(19) United States
(12) Patent Application Publication
(10) Pub. No.: US 2026/0016577 A1
(43) Pub. Date: Jan. 15, 2026

(54) DISTANCE MEASURING DEVICE

(71) Applicant: Panasonic Intellectual Property Management Co., Ltd., Osaka (JP)

(72) Inventor: TAKAYUKI KIYOHARA, Osaka (JP)

(21) Appl. No.: 19/331,670

(22) Filed: Sep. 17, 2025

Related U.S. Application Data
(63) Continuation of application No. PCT/JP2024/004347, filed on Feb. 8, 2024.

(30) Foreign Application Priority Data
Apr. 4, 2023 (JP) 2023-060819

(51) Int. Cl. G01S 7/4915; G01S 7/481; G01S 17/32

(52) U.S. Cl. CPC G01S 7/4915; G01S 7/4815; G01S 17/32

(57) ABSTRACT

A distance measuring device includes: a light source that emits first single-wavelength laser light with a first wavelength, and second single-wavelength laser light lower in frequency stability than the first single-wavelength laser light, with a second wavelength different from the first wavelength; an optical unit that causes interference between light beams, detects a first light component with the first wavelength among interfering light, and outputs a first signal, and detects a second light component with the second wavelength among the interfering light, and outputs a second signal; and a processing circuit that processes the first and second signals to calculate a first distance in a first range with first accuracy based on the first signal, and a second distance in a second range longer than the first range, with second accuracy lower than the first accuracy based on the first and second signals.

### BACKGROUND

### 1. Technical Field

The present disclosure relates to a distance measuring device.

### 2. Description of the Related Art

Optical interferometry using laser light is widely used as a unit to obtain information indicating the distance and/or shape of an object in a non-contact manner. As an example, a light detection and ranging (LiDAR) device using a frequency modulated continuous wave radar (FMCW) method is known as a three-dimensional measuring device with millimeter accuracy. Optical interferometry using optical coherence tomography (OCT) or an optical comb is known as a unit capable of achieving measurement with micrometer accuracy. These are widely utilized in the medical field and/or the industrial field.

In addition, measurement with nanometer accuracy is made possible by controlling optical interference phenomenon with higher accuracy. For example, a Michelson interferometer using a single-wavelength laser is a method to measure a difference in distance in nanometer unit as a light intensity.

Optical measurement with nanometer accuracy representing homodyne optical interferometry enables highly accurate measurement in a non-contact manner, but has a problem in that the measurement range is limited to a submicron scale range which is half the wavelength. Thus, in some cases, measurement of a sample having both a nanometric-scale structure and several tens micron scale structure is difficult.

As a method to address this problem, multi-wavelength interferometry is expected, which is optical interferometry using two or more single-wavelength laser light beams. The multi-wavelength interferometry can eliminate the trade-off challenge between the measurement range and the measurement accuracy in related art, and can achieve a long measurement range and a high measurement accuracy concurrently.

For example, the specification of German Patent No. 102015209567 states that the trade-off challenge between the measurement range and the measurement accuracy in related art can be eliminated by combining the results of optical interference of laser light beams with different wavelengths so that a long measurement range and a high measurement accuracy can be achieved.

### SUMMARY

In one general aspect, the techniques disclosed here feature a distance measuring device including: a light source that emits first single-wavelength laser light with a first wavelength, and second single-wavelength laser light with a second wavelength different from the first wavelength; an optical unit that causes interference between a plurality of light beams incident on the optical unit, detects a first light component with the first wavelength among interfering light generated by the interference of the plurality of light beams, and outputs a first signal according to a result of a detection of the first light component, and detects a second light component with the second wavelength among the interfering light, and outputs a second signal according to a result of a detection of the second light component; and a processing circuit that processes the first signal and the second signal. The processing circuit calculates a first distance in a first range with a first accuracy based on the first signal, calculates a second distance in a second range with a second accuracy based on the first signal and the second signal. The first accuracy is higher than the second accuracy. The second range is longer than the first range. A frequency stability of the first single-wavelength laser light is higher than a frequency stability of the second single-wavelength laser light.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a block diagram illustrating the configuration of a distance measuring device according to an embodiment;

FIG. 2 is a block diagram illustrating the configuration of a light source of the distance measuring device according to the embodiment;

FIG. 3 is a view illustrating the specific configuration of an optical unit of the distance measuring device according to the embodiment;

FIG. 4 is a view for explaining the principle of first measurement using single-wavelength laser light performed by the distance measuring device according to the embodiment;

FIG. 5 is a view for explaining the principle of second measurement using a plurality of single-wavelength laser light beams performed by the distance measuring device according to the embodiment;

FIG. 6 is a view illustrating the measurement ranges and the measurement accuracies of two measurements made by the distance measuring device according to the embodiment;

FIG. 7 is a view for explaining the stability of the frequency of single-wavelength laser light;

FIG. 8 is a flowchart illustrating an example of an operation of the distance measuring device according to the embodiment;

FIG. 9 is a flowchart illustrating another example of an operation of the distance measuring device according to the embodiment; and

FIG. 10 is a block diagram illustrating the configuration of a light source of a distance measuring device according to a modification of the embodiment.

### DETAILED DESCRIPTIONS

The distance measuring device using the principle of multi-wavelength interferometry (MWI) as disclosed in German Patent No. 102015209567 needs two or more single-wavelength laser light beams having different wavelengths. In this situation, when the stabilities of the frequencies of two or more single-wavelength laser light beams are different, the distance measurement accuracy may be reduced depending on the combination of wavelengths used for distance calculation.

Thus, the present disclosure provides a distance measuring device that can achieve both a long measurement range and a higher measurement accuracy.

### Overview of Present Disclosure

First, the definition of important terms used in the present specification will be stated below.

The “measurement accuracy” refers to the degree of accuracy when a distance is measured. In other words, the measurement accuracy is a scale for determining how accurately distance information could be obtained. Thus, it can be stated that more accurate measurement can be performed for a higher measurement accuracy.

The “measurement range” refers to a range in the direction of distance, the range allowing unique distance information to be obtained. In other words, the measurement range indicates a range which enables distance measurement.

In the present specification, each of the measurement accuracy and the measurement range is expressed in terms of the same dimension as that of distance. Specifically, the unit for the measurement accuracy and the unit for the measurement range are each expressed in terms of nanometer (nm), micrometer (μm), millimeter (mm) or the like. Thus, the “measurement accuracy is high” is synonymous with the “measurement accuracy is short” expressed in terms of the dimension of distance. The “measurement accuracy is low” is synonymous with the “measurement accuracy is long” expressed in terms of the dimension of distance. In the present specification, the measurement accuracy may be simply referred to as the “accuracy”. The measurement range may be simply referred to as the “range”.

Distance measurement in the measurement range is called “absolute distance measurement”. For example, distance measurement with an accuracy of 10 nm and a measurement range of 1 mm is absolute distance measurement capable of distinguishing a difference of 10 nm in a range of 1 mm.

A plurality of aspects of the distance measuring device according to the present disclosure are as follows.

A distance measuring device according to a first aspect of the present disclosure includes a light source, an optical unit, and a processing circuit. The light source emits first single-wavelength laser light with a first wavelength, and second single-wavelength laser light with a second wavelength different from the first wavelength. The optical unit causes interference between a plurality of light beams incident on the optical unit, detects a first light component with the first wavelength among interfering light generated by the interference of the plurality of light beams, and outputs a first signal according to a result of a detection of the first light component, and detects a second light component with the second wavelength among the interfering light, and outputs a second signal according to a result of a detection of the second light component. The processing circuit processes the first signal and the second signal. The processing circuit calculates a first distance in a first range with a first accuracy based on the first signal, and calculates a second distance in a second range with a second accuracy based on the first signal and the second signal. The first accuracy is higher than the second accuracy. The second range is longer than the first range. A frequency stability of the first single-wavelength laser light is higher than a frequency stability of the second single-wavelength laser light.

Consequently, the first measurement can be performed based on the first single-wavelength laser light having high frequency stability, thus both a long measurement range and a higher measurement accuracy can be achieved. A laser light source having high frequency stability is expensive in general. According to the present aspect, the frequency stability of laser light from a light source other than the light source to emit the first single-wavelength laser light may be low. Therefore, for example, as the light source to emit the second single-wavelength laser light, an inexpensive light source can be adopted, thus reduction in the cost is also expected.

A distance measuring device according to a second aspect of the present disclosure is the distance measuring device according to the first aspect in which the second accuracy may be less than or equal to the first range.

Consequently, the first distance calculated by the first measurement and the second distance calculated by the second measurement can be combined as appropriate, thus higher measurement accuracy can be achieved.

A distance measuring device according to a third aspect of the present disclosure is the distance measuring device according to the second aspect in which the processing circuit may further calculate a distance from the distance measuring device to an object based on the first distance and the second distance.

In this manner, the processing circuit calculates the distance from the distance measuring device to an object, thus for example, a user does not have to calculate the distance by hand calculation, and convenience of a user is enhanced.

A distance measuring device according to a fourth aspect of the present disclosure is the distance measuring device according to the third aspect in which the processing circuit may calculate an absolute distance from the distance measuring device to the object.

Consequently, the absolute distance from the distance measuring device to an object can be calculated, thus the distance measuring device is useful, for example, for inspection or the like of the surface profile of the object.

A distance measuring device according to a fifth aspect of the present disclosure is the distance measuring device according to any one of the first to fourth aspects in which the plurality of light beams may include the first single-wavelength laser light, the second single-wavelength laser light, first reflected light generated by reflection of the first single-wavelength laser light on an object, and second reflected light generated by reflection of the second single-wavelength laser light on the object, and the optical unit may output the first signal by causing interference between the first single-wavelength laser light and the first reflected light and detecting the first light component, and may output the second signal by causing interference between the second single-wavelength laser light and the second reflected light and detecting the second light component.

Thus, the intensity signal of interfering light for each wavelength can be easily obtained by utilizing homodyne interferometry.

A distance measuring device according to a sixth aspect of the present disclosure is the distance measuring device according to the fifth aspect in which the optical unit may include a beam splitter, a first light detector, and a second light detector, the beam splitter may split the first single-wavelength laser light from the light source into first reference light and first detection light, and may split the second single-wavelength laser light from the light source into second reference light and second detection light, the first reflected light is generated by reflection of the first detection light on the object, the second reflected light is generated by reflection of the second detection light on the object, the first light detector may output the first signal by detecting the first light component generated by interference between the first reference light and the first reflected light, and the second light detector may output the second signal by detecting the second light component generated by interference between the second reference light and the second reflected light.

Thus, interference can be caused by the beam splitter, and an interference signal for each wavelength can be obtained by two light detectors with high accuracy.

A distance measuring device according to a seventh aspect of the present disclosure is the distance measuring device according to the sixth aspect in which the optical unit may include an optical element that causes the first reference light and the second reference light to be incident on the beam splitter, and a wavelength-separation element that separates incident light into light with the first wavelength and light with the second wavelength, and the beam splitter may emit at least part of each of the first reflected light and the second reflected light from the object, and at least part of each of the first reference light and the second reference light from the optical element to the wavelength-separation element.

Consequently, a Michelson interferometer is constructed, thus the optical path of each laser light is easily formed, and the distance measurement with high accuracy is made possible.

A distance measuring device according to an eighth aspect of the present disclosure is the distance measuring device according to any one of the fifth to seventh aspects in which the processing circuit may correct the second signal based on the first signal.

Consequently, the accuracy of the second measurement can be increased.

A distance measuring device according to a ninth aspect of the present disclosure is the distance measuring device according to any one of the first to eighth aspects in which a set frequency of the first single-wavelength laser light and a set frequency of the second single-wavelength laser light may be fixed during a measurement period.

Consequently, the variation of the frequency during the measurement period is reduced, thus the measurement accuracy can be increased.

A distance measuring device according to a tenth aspect of the present disclosure is the distance measuring device according to any one of the first to ninth aspects in which the light source may further emit third single-wavelength laser light with a third wavelength different from any of the first wavelength and the second wavelength.

Thus, the measurement range can be further increased by utilizing the three wavelengths. Note that four or more wavelengths may be utilized, then the measurement range can be further increased.

A distance measuring device according to an eleventh aspect of the present disclosure is the distance measuring device according to the tenth aspect in which the first single-wavelength laser light may have highest frequency stability among all single-wavelength laser light emitted by the light source.

Thus, it is possible to achieve measurement with the highest accuracy among the combinations of the wavelengths of the laser light which can be emitted.

A distance measuring device according to a twelfth aspect of the present disclosure is the distance measuring device according to the tenth or eleventh aspect in which the optical unit may further detect a third light component with the third wavelength among the interfering light, and may output a third signal according to a result of a detection of the third light component, the processing circuit may further calculate a third distance in a third range with a third accuracy based on the first signal and the third signal, the third accuracy may be lower than the second accuracy, and the third range may be longer than the second range.

Thus, the measurement range can be further increased. Therefore, both a longer measurement range and a higher measurement accuracy can be achieved.

A distance measuring device according to a thirteenth aspect of the present disclosure is the distance measuring device according to any one of the first to twelfth aspects in which the processing circuit may calculate the second distance by calculating a phase of a beat wavelength between the first wavelength and the second wavelength based on the first signal and the second signal.

Consequently, distance calculation with a long measurement range is made possible based on the beat wavelength.

A distance measuring device according to a fourteenth aspect of the present disclosure is the distance measuring device according to the thirteenth aspect in which the processing circuit may calculate the first distance by calculating a phase of the first wavelength based on the first signal, and may calculate an absolute distance from the distance measuring device to an object by combining the first distance and the second distance.

Consequently, the absolute distance from the distance measuring device to an object can be calculated, thus the distance measuring device is useful, for example, for inspection or the like of the surface profile of an object.

A distance measuring device according to a fifteenth aspect of the present disclosure is the distance measuring device according to any one of the first to fourteenth aspects in which the light source may include a first laser light source that emits the first single-wavelength laser light, and a second laser light source that emits the second single-wavelength laser light.

Consequently, a plurality of single-wavelength laser light beams can be easily emitted by providing a laser light source for each wavelength.

In the following, embodiments will be specifically described with reference to the drawings.

Note that each of the embodiments described below illustrates a general or specific example. The numerical values, shapes, materials, structural components, the arrangement and connection of the structural components, steps, the sequence of the steps shown in the following embodiments are mere examples, and are not intended to limit the scope of the present disclosure. Those components in the following embodiments, which are not stated in the independent claim that defines the most generic concept are each described as an arbitrary component.

Note that each of the drawings is schematically illustrated, and is not necessarily illustrated accurately. Therefore, for instance, the scales used in the drawings are not necessarily the same. In the drawings, essentially the same components are labeled with the same symbol, and a redundant description may be omitted or simplified.

In the present specification, terms indicating a relationship between elements, such as parallel or perpendicular, terms indicating the shape of an element, and numerical value ranges do not refer to the meaning of the terms only in a strict sense, but refer to the meaning of the terms including substantially equivalent ranges, for example, ranges with a difference of several percentages.

In the present specification, an ordinal number such as “first”, “second” does not mean the number or order of components unless otherwise specified, and is used for the purpose of distinguishing between similar components while avoiding confusion therebetween.

### Embodiments

### 1. Configuration of Distance Measuring Device

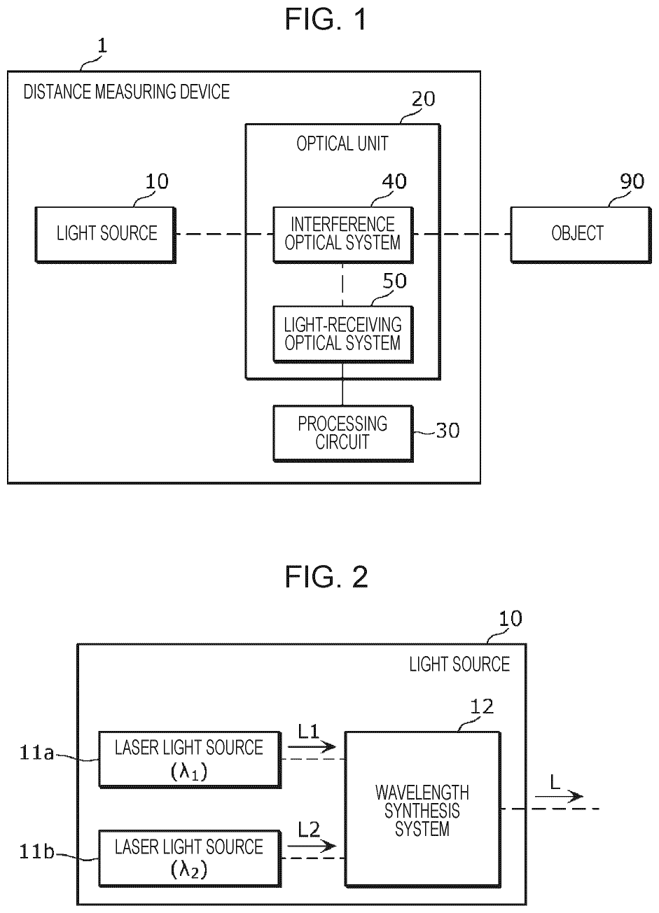

First, the configuration of a distance measuring device according to the embodiment will be described with reference to FIG. 1. FIG. 1 is a block diagram illustrating the configuration of a distance measuring device 1 according to the present embodiment.

The distance measuring device 1 illustrated in FIG. 1 measures the distance from the distance measuring device 1 to an object 90. Specifically, the distance measuring device 1 can obtain information indicating the surface profile of the object 90 by measuring the distance to each point of the object 90. The distance measuring device 1 can be utilized for e.g., appearance inspection of products or the like.

As illustrated in FIG. 1, the distance measuring device 1 includes a light source 10, an optical unit 20, and a processing circuit 30. The distance measuring device 1 may include a support member (not illustrated) that supports the object 90. The support member includes a drive unit such as a motor and a piezoelectric element, and may be able to change the posture and/or position of the object 90.

The light source 10 emits a plurality of single-wavelength laser light beams. FIG. 2 is a block diagram illustrating the configuration of the light source 10 of the distance measuring device 1 according to the present embodiment. As illustrated in FIG. 2, the light source 10 includes laser light sources 11a and 11b, and a wavelength synthesis system 12.

The laser light sources 11a and 11b respectively emit single-wavelength laser light beams with different wavelengths. The laser light sources 11a and 11b are e.g., semiconductor laser elements, and upon receipt of a current supplied, emit predetermined single-wavelength laser light.

The laser light source 11a is an example of a first laser light source, and emits laser light L1 with a wavelength λ₁. The wavelength λ₁ is an example of a first wavelength, and the laser light L1 is an example of first single-wavelength laser light.

The laser light source 11b is an example of a second laser light source, and emits laser light L2 with a wavelength λ₂. The wavelength λ₂ is an example of a second wavelength, and the laser light L2 is an example of second single-wavelength laser light. The wavelength λ₂ is different from the wavelength λ₁. In the present embodiment, the wavelength λ₂ is longer than the wavelength λ₁.

The wavelength synthesis system 12 synthesizes the laser light L1 and L2 emitted from the two laser light sources 11a and 11b, respectively. The light beams L emitted from the wavelength synthesis system 12 are combined in an interference optical system 40. The wavelength synthesis system 12 is e.g., a dense wavelength division multiplexing (DWDM) device, or a holographic optical element.

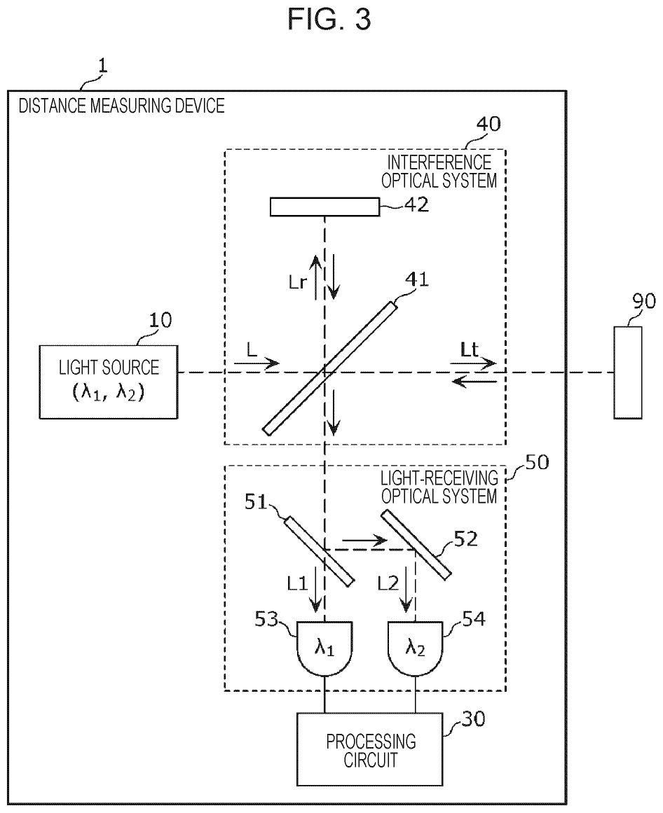

The optical unit 20 is an example of an optical unit that causes interference between the light beams incident on the optical unit 20 to detect an optical component, and outputs a signal according to a result of the interference. The optical unit 20 receives the laser light L1 and L2 from the light source 10, first reflected light generated by reflection of the laser light L1 on the object 90, and second reflected light generated by reflection of the laser light L2 on the object 90. As illustrated in FIG. 1, the optical unit 20 includes an interference optical system 40, and a light-receiving optical system 50. Specific configurations of the interference optical system 40 and the light-receiving optical system 50 will be described below with reference to FIG. 3.

The processing circuit 30 is a signal processing circuit that processes the signal output from the optical unit 20. Specifically, the processing circuit 30 calculates the distance from the distance measuring device 1 to the object 90. For example, the processing circuit 30 obtains the position of the object 90 as phase information by processing, based on a predetermined algorithm, the signal output from the optical unit 20 based on an interference result. Four-step phase-shifting algorithm or the like can be used as a typical phase estimation algorithm. The processing circuit 30 can calculate the distance from the distance measuring device 1 to the object 90 based on the phase information.

Specifically, the processing circuit 30 calculates a first distance in a first measurement range with a first measurement accuracy based on an interference result corresponding to the wavelength λ₁. In addition, the processing circuit 30 calculates a second distance in a second measurement range with a second measurement accuracy based on an interference result corresponding to the wavelength λ₁ and the wavelength λ₂. The processing circuit 30 calculates the distance from the distance measuring device 1 to the object 90 based on the first distance and the second distance. The processing circuit 30 calculates the absolute distance from the distance measuring device 1 to the object 90.

Here, the first measurement accuracy is higher than the second measurement accuracy. The second measurement range is longer than the first measurement range. Thus, simply stated in other words, the processing circuit 30 calculates the distance in a short measurement range with a high measurement accuracy based on the interference result for one wavelength. The processing circuit 30 calculates the distance in a long measurement range with a low measurement accuracy based on the interference result for two wavelengths. A specific distance calculation method will be described later.

The processing circuit 30 is implemented by a large scale integration (LSI) integrated circuit. For example, the processing circuit 30 may be implemented by a dedicated hardware configuration, and may calculate the distance from the distance measuring device 1 to the object 90. Alternatively, the processing circuit 30 may include a processor and a memory, and may calculate the distance from the distance measuring device 1 to the object 90 by causing the processor to execute a program stored in the memory. Specifically, the processing circuit 30 may include: a non-volatile memory that stores a program; a volatile memory which is a temporary storage area for executing a program; an input/output port; and a processor to execute a program. Alternatively, the processing circuit 30 may be a field programmable gate array (FPGA) which can be programmed, or a reconfigurable processor which can reconfigure connection and setting of circuit cells in an LSI.

### 1.1. Specific Configuration of Optical Unit

Subsequently, the specific configuration of the optical unit 20 will be described. As mentioned above, the optical unit 20 includes the interference optical system 40, and the light-receiving optical system 50. In the following, respective configurations will be sequentially described with reference to FIG. 3. FIG. 3 is a view illustrating the specific configuration of the optical unit 20 of the distance measuring device 1 according to the present embodiment.

In the present embodiment, the interference optical system 40 is an optical system utilizing Michelson interferometry. As illustrated in FIG. 3, the interference optical system 40 includes a beam splitter 41, and a mirror 42.

The beam splitter 41 is an optical element that splits the light incident on the beam splitter 41 into a plurality of light beams by intensity, and emits the plurality of light beams in different directions. The beam splitter 41 is e.g., a half mirror, and splits the light incident on the beam splitter 41 into transmitted light and reflected light with the same intensity. Note that the intensity ratio between the transmitted light and the reflected light may not be 1:1.

Specifically, the beam splitter 41 splits the laser light L1 from the light source 10 into first detection light and first reference light, and splits the laser light L2 from the light source 10 into second detection light and second reference light. The first detection light and the second detection light are emitted to the object 90. The first reference light and the second reference light are emitted to the mirror 42.

The mirror 42 is an example of an optical element that causes the first reference light and the second reference light from the beam splitter 41 to be incident on the beam splitter. Specifically, the mirror 42 causes the light incident on the mirror 42 to be specularly reflected. For a higher reflectance, loss of light reduces, thus the detection accuracy can be increased.

In the example illustrated in FIG. 3, the laser light from the light source 10, that is, synthetic light L of the laser light L1 and L2 is incident on the beam splitter 41. The beam splitter 41 transmits part of the synthetic light L as transmitted light Lt, and reflects another part as reflected light Lr. The transmitted light Lt includes the first detection light and the second detection light, and is emitted to the object 90. The reflected light Lr includes the first reference light and the second reference light, and is emitted to the mirror 42.

The transmitted light Lt emitted to the object 90 is reflected by the object 90, and is incident on the beam splitter 41 again. Part of the transmitted light Lt incident on the beam splitter 41 again is reflected and emitted to the light-receiving optical system 50. The transmitted light Lt incident on the beam splitter 41 again includes: reflected light (in other words, the first reflected light) produced by reflection on the object 90 of the first detection light which is part of the laser light L1; and reflected light (in other words, the second reflected light) produced by reflection on the object 90 of the second detection light which is part of the laser light L2.

Similarly, the reflected light Lr emitted to the mirror 42 is reflected by the mirror 42, and is incident on the beam splitter 41 again. Part of the reflected light Lr incident on the beam splitter 41 again transmits therethrough, and is emitted to the light-receiving optical system 50. The reflected light Lr incident on the beam splitter 41 again includes the first reference light of the laser light L1 and the second reference light of the laser light L2.

Note that the install positions of the mirror 42 and the object 90 are replaceable. In other words, when the synthetic light L from the light source 10 is split into the transmitted light Lt and the reflected light Lr by the beam splitter 41, the transmitted light Lt may be emitted to the mirror 42, and the reflected light Lr may be emitted to the object 90.

The interference optical system 40 is not limited to an optical system utilizing Michelson interferometry. The interference optical system 40 may be an optical system utilizing Fizeau interferometry or Mach-Zehnder interferometry.

The light-receiving optical system 50 is an optical system utilizing homodyne interferometry. As illustrated in FIG. 3, the light-receiving optical system 50 includes a dichroic mirror 51, a mirror 52, and light detectors 53 and 54.

The dichroic mirror 51 is an example of a wavelength division element that separates the light incident on the dichroic mirror 51 into light with the wavelength λ₁ and light with the wavelength λ₂. Specifically, the dichroic mirror 51 separates the light incident on the light-receiving optical system 50 from the beam splitter 41 by wavelength. In the present embodiment, the dichroic mirror 51 emits the light with the wavelength λ₁ to the light detector 53, and emits the light with the wavelength λ₂ to the light detector 54. In the present embodiment, the mirror 52 is provided for optical path adjustment.

The mirror 52 causes the light with the wavelength λ₂ separated by the dichroic mirror 51 to be specularly reflected and emitted to the light detector 54. Note that instead of the mirror 52, the light detector 54 may be disposed at the position of the mirror 52. Alternatively, the mirror 52 may be provided for the purpose of adjusting the optical path of the light with the wavelength M.

The light detectors 53 and 54 each include a photoelectric conversion element that generates an electrical signal according to the intensity of the incident light. The light detector 53 is an example of a first light detector, has a sensitivity to at least the wavelength λ₁, and photoelectrically converts the light with the wavelength 2, thereby outputting a first signal to the processing circuit 30, the first signal having a signal level according to the intensity. The first signal is obtained by detecting the interfering light between the laser light L1 reflected by the mirror 42 and reflected light of the laser light L1 due to reflection on the object 90.

The light detector 54 is an example of the second light detector, has a sensitivity to at least the wavelength λ₂, and photoelectrically converts the light with the wavelength λ₂, thereby outputting a second signal to the processing circuit 30, the second signal having a signal level according to the intensity. The second signal is obtained by causing interference between the laser light L2 reflected by the mirror 42 and reflected light of the laser light L2 due to reflection on the object 90, and detecting a light component.

Note that as long as the light receiving-optical system 50 can receive light for cach wavelength, the configuration thereof is not limited to the above example. For example, the light from the beam splitter 41 to the light-receiving optical system 50 is split into two light beams by intensity, and the two split light beams may be passed through a filter having a passband for a specific wavelength component. As the filter, for example, a bandpass filter is utilized, but a low pass filter, a high pass filter and the like may be utilized.

The light-receiving optical system 50 may not be an optical system utilizing homodyne interferometry. The light-receiving optical system 50 may be an optical system utilizing heterodyne interferometry. In this case, the light-receiving optical system 50 may not include the dichroic mirror 51 that performs wavelength splitting, and the number of light detectors may be one.

### 2. Principle of Distance Measurement

Next, the principle of the distance measurement by the distance measuring device 1 according to the present embodiment will be described.

In the distance measuring device 1 according to the present embodiment, distance measurement is performed based on multi-wavelength interferometry (MWI) using a plurality of single-wavelength laser light beams. The MWI can eliminate the trade-off challenge between the measurement range and the measurement accuracy in related art to achieve a long measurement range and a high measurement accuracy by combining the results of interference between a plurality of single-wavelength laser light beams with different wavelengths. In the following, the principle of the multi-wavelength interferometry will be described.

### 2.1. First Measurement (One Wavelength Is Utilized)

First, the first measurement using one single-wavelength laser light will be described.

As described above with reference to FIG. 3, in homodyne optical interferometry, single-wavelength laser light is separated by the beam splitter 41 and emitted to the mirror 42 serving as a reference surface and the object 90 as a target of distance measurement. Respective reflected light beams from the mirror 42 and the object 90 are caused to interfere at the beam splitter 41. When the interfering light is detected by the light detector 53, an intensity PPD of the signal output from the light detector 53 is represented by the following Expression (1).

$${P}_{PD} ∝ 1 - cos ( \frac{4 π L}{{λ}_{k}} ) \qquad ( 1 )$$

In Expression (1), L−=Lx−Ly. Lx is the distance from the beam splitter 41 to the reflective surface of the mirror 42. Ly is the distance from the beam splitter 41 to the object 90. λₖ is the wavelength of the single-wavelength laser light. Herein, k=1. Each of Lx and λₖ is a value known to the processing circuit 30. Thus, the processing circuit 30 can calculate the distance Ly to the object 90 based on the signal intensity PPD.

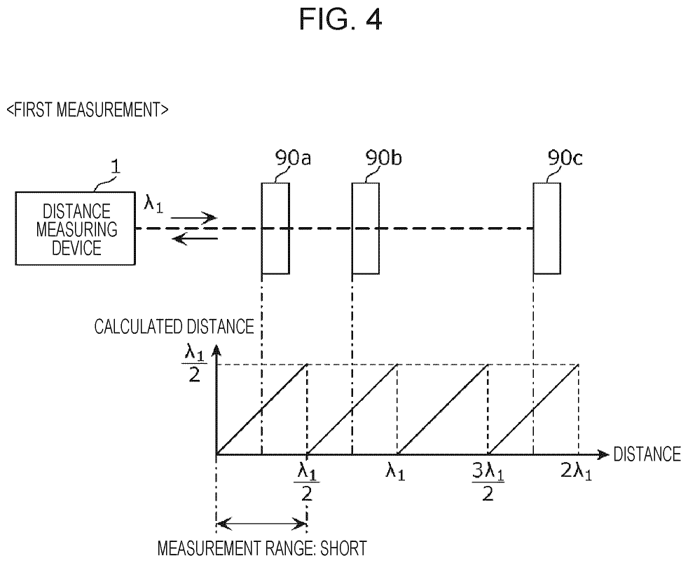

The first measurement is disadvantageous in that the measurement range is relatively short. In the following, the relationship between the position of the object 90 and the measurement range will be described with reference to FIG. 4.

FIG. 4 is a view for explaining the principle of the first measurement using single-wavelength laser light performed by the distance measuring device 1 according to the present embodiment. In FIG. 4, objects 90a, 90b and 90c each indicate that the corresponding object 90 illustrated in FIGS. 1 and 3 is located at a different position. When there is no need to distinguish between the position, a description will be given using the expression “object 90”.

FIG. 4 illustrates a graph in which the horizontal axis represents distance to the object 90 relative to a reference point at a predetermined position, and the vertical axis represents calculated distance which is the distance calculated by the processing circuit 30. As illustrated in FIG. 4, the processing circuit 30 can calculate the distance to the object 90 in a predetermined measurement range. As seen from Expression (1), the measurement range is half wavelength (λ₁/2), where λ₁ is the wavelength of the single-wavelength laser light.

In the first measurement, when a target distance exceeds the measurement range, the absolute distance from the distance measuring device 1 to the object 90 cannot be calculated. For example, in the example illustrated in FIG. 4, the distances to the objects 90a, 90b and 90c are all calculated as the same distance.

The wavelength of the single-wavelength laser light is, for example, the wavelength of the near-infrared light band or the visible light band. The near-infrared light band refers to a wavelength band of approximately 700 to 2500 nm. The visible light band refers to a wavelength band of approximately 380 to 780 nm. In this situation, the measurement range in the first measurement is approximately 190 to 1250 nm. In other words, the measurement range in the first measurement is from the order of several hundred nanometers to the order of several micrometers. Like this, the measurement range in the first measurement is relatively smaller than that in the second measurement described below.

### 2.2. Second Measurement (Two Wavelengths Are Utilized)

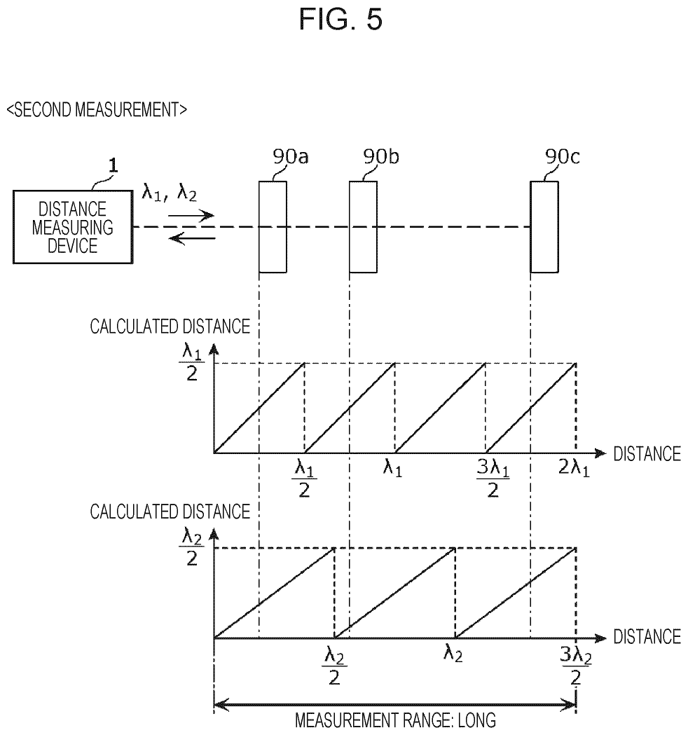

Next, the second measurement utilizing two single-wavelength laser light beams with different wavelengths in order to address the disadvantage of the first measurement, that is, a short measurement range will be described with reference to FIGS. 3 and 5.

As illustrated in FIG. 3, in the distance measuring device 1 according to the present embodiment, the light beams caused to interfere at the beam splitter 41 are divided by the dichroic mirror 51 according to the wavelength, and detected by two light detectors 53 and 54. As a result, from each of the light detector 53 and 54, a signal corresponding to a result of homodyne optical interferometry is output for each corresponding wavelength. The processing circuit 30 can calculate the distance to the object 90 based on the two signals.

In the second measurement, the measurement range is increased by combining the two signals. In the following, the relationship between the position of the object 90 and the measurement range will be described with reference to FIG. 5.

FIG. 5 is a view for explaining the principle of the second measurement using two single-wavelength laser light beams performed by the distance measuring device 1 according to the present embodiment. In FIG. 5, objects 90a, 90b and 90c each indicate that the corresponding object 90 illustrated in FIGS. 1 and 3 is located at a different position. When there is no need to distinguish between the position, a description will be given using the expression “object 90”.

FIG. 5 illustrates two graphs in which the horizontal axis represents distance to the object 90 relative to a reference point at a predetermined position, and the vertical axis represents calculated distance which is the distance calculated by the processing circuit 30. The upper graph between the two graphs is the same as the graph illustrated in FIG. 4, and shows the distance calculated based on the signal obtained from one of the two light detectors 53 and 54. The lower graph between the two graphs shows the distance calculated based on the signal obtained from the other one of the two light detectors 53 and 54.

When the two graphs are each utilized singly, the order of the measurement range hardly different from the order in the first measurement because the measurement ranges are λ₁/2 and λ₂/2, respectively. In the second measurement, the measurement range can be increased by combining the two graphs.

Specifically, the distances calculated corresponding to the upper graph for the objects 90a, 90b, 90c are approximately the same. However, the distances calculated corresponding to the lower graph are different from each other. Thus, by combining two calculation results, the distance can be calculated with a measurement range longer than any of λ₁/2 and λ₂/2. Specifically, the processing circuit 30 calculates the absolute distance to the object 90 by combining the first distance obtained by the first measurement, and the second distance obtained by the second measurement.

The measurement range in the second measurement is half the beat wavelength between the two single-wavelength laser light beams. For example, let λ₁ and λ₂ be the wavelengths of the two single-wavelength laser light beams, then the beat wavelength Λ₁₂ is represented by the following Expression (2).

$${Λ}_{12} = \frac{{λ}_{1} {λ}_{2}}{\vert {λ}_{1} - {λ}_{2} \vert} \qquad ( 2 )$$

Optical interferometry with the beat wavelength Λ₁₂ enables the distance measurement with a measurement range corresponding to half the beat wavelength Λ₁₂. For example, when λ₁ and λ₂ are 1550 nm and 1551 nm, respectively, the beat wavelength Λ₁₂ is 2.4 mm, and the measurement range is 1.2 mm. The measurement range in the case of single wavelength interferometry is approximately 775 nm which is in the order of nanometer, whereas the measurement range of the MWI is expanded to the order of millimeter.

### 2.3 Measurement Accuracy

Subsequently, the measurement accuracy of each of the first measurement and the second measurement will be described.

The measurement accuracy depends on the wavelength of the single-wavelength laser light utilized for the measurement. Specifically, the shorter the wavelength of the single-wavelength laser light, the higher the measurement accuracy (in other words, the smaller the precision in the dimension of distance), and the longer the wavelength of the single-wavelength laser light, the lower the measurement accuracy (in other words, the larger the precision in the dimension of distance).

When two single-wavelength laser light beams are utilized as in the second measurement, the measurement accuracy depends on the beat wavelength. Specifically, the shorter the beat wavelength, the higher the measurement accuracy (in other words, the smaller the precision in the dimension of distance), and the longer the beat wavelength, the lower the measurement accuracy (in other words, the larger the precision in the dimension of distance).

Since the beat wavelength is longer than the wavelength of the single-wavelength laser light, the measurement accuracy in the second measurement is lower than that in the first measurement. In other words, the measurement accuracy of the second measurement depends on the beat wavelength Λ₁₂, thus deteriorates. Thus, the trade-off between the measurement range and the measurement accuracy is not eliminated only by utilizing the second measurement.

In order to eliminate the trade-off, the MWI combines the first measurement and the second measurement, thereby achieving both a long measurement range and a high measurement accuracy concurrently. Specifically, both a long measurement range and a high measurement accuracy are achieved by combining the first measurement in which the measurement range is short, but the measurement accuracy is high, and the second measurement in which the measurement accuracy is low, but the measurement range is long.

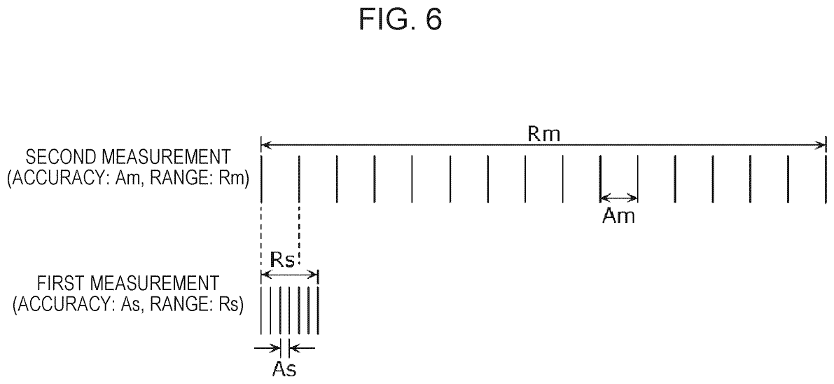

FIG. 6 is a view illustrating the measurement range and the measurement accuracy of two measurements made by the distance measuring device 1 according to the present embodiment. As illustrated in FIG. 6, let Am be the measurement accuracy (the second measurement accuracy) in the second measurement, and let Rm be the measurement range (the second measurement range) in the second measurement. Also, let As be the measurement accuracy (the first measurement accuracy) in the first measurement, and let Rs be the measurement range (the first measurement range) in the first measurement. Each of the measurement range and the measurement accuracy is represented by the dimension of distance, thus comparison is possible.

As described above, and as illustrated in FIG. 6, Rm>Rs and Am>As are satisfied. In the present embodiment, Am≤Rs is satisfied. That is, the measurement accuracy Am of the second measurement is less than or equal to the measurement range Rs of the first measurement. Consequently, the first measurement and the second measurement can be combined in a unique manner, thus distance measurement with a measurement accuracy higher than the measurement accuracy of the second measurement is made possible.

In order to achieve higher measurement accuracy, selection of single-wavelength laser light to be utilized for the first measurement is important. The inventor of the present application has found through intensive studies that the stability of the frequency of the single-wavelength laser light is important for the improvement of the measurement accuracy. In the following, the relationship between the stability of the frequency and the measurement accuracy will be described.

### 3. Relationship Between Stability of Frequency and Measurement Accuracy

The frequency of the single-wavelength laser light is adjusted so as to be maintained at a predetermined set value by a controller which is not illustrated. Specifically, the frequency is to be held at a constant value by adjusting the amount of current supplied to the laser light source and/or the temperature of the laser light source. In the present embodiment, the set frequency of the light source 10 is controlled at a fixed value during a measurement period.

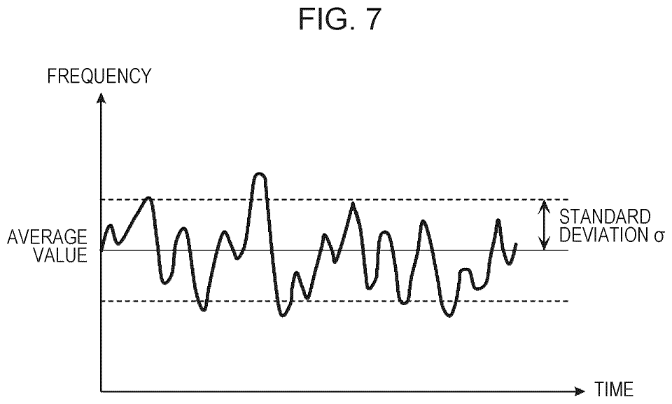

However, due to the characteristics of the laser light source, it is not possible to maintain the frequency at a constant value. As illustrated in FIG. 7, the frequency of the single-wavelength laser light varies with time, i.e., fluctuates. Note that FIG. 7 is a view for explaining the stability of the frequency of the single-wavelength laser light. In FIG. 7, the horizontal axis represents time, and the vertical axis represents frequency of single-wavelength laser light.

The wavelength λₖ of the single-wavelength laser light is expressed by light speed/frequency. Since the light speed is considered to be constant, when the frequency fluctuates, the wavelength λₖ also fluctuates. As seen from the above-mentioned Expression (1), when the wavelength λₖ fluctuates, a discrepancy occurs between the wavelength of the single-wavelength laser light actually utilized in the measurement, and the wavelength in the calculation

For this reason, a variation occurs in the value of calculated distance, thus the measurement accuracy is reduced. Thus, a correlation is observed between the fluctuation of the frequency and the measurement accuracy. Specifically, the lower the fluctuation, the higher the measurement accuracy.

Therefore, in the first measurement which requires high accuracy, between the two single-wavelength laser light beams, the one with a lower fluctuation is utilized. In other words, between the two single-wavelength laser light beams, the one with a higher frequency stability is utilized.

Note that the stability of the frequency is represented by a value having a negative correlation with the fluctuation of the frequency of laser light for time change. Specifically, the lower the fluctuation, the higher the stability of the frequency, and the higher the fluctuation, the lower the stability of the frequency.

The fluctuation is represented, for example, by a standard deviation o illustrated in FIG. 7. The standard deviation σ can be statistically calculated relative to the average (the median) of the frequency of laser light in a finite time. Note that the fluctuation of the frequency may be expressed in wavelength unit instead of frequency unit, or alternatively, may be expressed in another unit having a correlation with the frequency.

In the present embodiment, λ₁<λ₂, thus the fluctuation of the frequency of the laser light L1 is lower than the fluctuation of the frequency of the laser light L2. Thus, for the first measurement, the laser light L1 with the wavelength λ₁ can be utilized.

Note that as the laser light source 1 la for emitting the laser light L1, it is possible to use a distributed feedback (DFB) laser light source having high frequency stability characteristics, or a light source device in which an absorption line of a gas cell as a reference frequency, and a semiconductor laser are combined.

### 4. Calculation of Absolute Distance

In the following, an example of a method for calculating an absolute distance to the object 90 by the MWI using two single-wavelength laser light beams will be described.

In the second measurement, the phases of wavelengths are calculated based on respective signals from the two light detectors 53 and 54 illustrated in FIG. 3, and the difference in the phases is obtained as the phase of the beat wavelength Λ₁₂. When the conditions for performing the MWI are satisfied, a wave number N of the wavelength λ₁ of the laser light L1 with a lower fluctuation of the frequency is determined from the components of the quotient obtained by dividing a rough distance calculated from the phase of the beat wavelength Λ₁₂ by the wavelength λ₁ of the laser light L1. Next, in the first measurement, a phase φ of the single wavelength is calculated based on the signal from one (herein, the light detector 53) of the two light detectors 53 and 54 illustrated in FIG. 3. An absolute distance x is calculated using the following Expression (3) based on the above results.

$$x = \frac{{λ}_{1}}{2} ( N + \frac{ϕ}{2 π} ) \qquad ( 3 )$$

φ is a principal cause of fluctuating components of the calculated distance x, and is caused by the fluctuation of the frequency of the first single-wavelength laser light. Thus, an optimal combination of wavelengths is given by the laser light used in the first measurement, having the lowest fluctuation of the frequency, in other words, having the highest frequency stability. Although the details will be described later, even with the number of wavelengths of 3 or more, the technique according to the present disclosure can be applied by a similar procedure.

### 5. Operation (Distance Measurement Method)

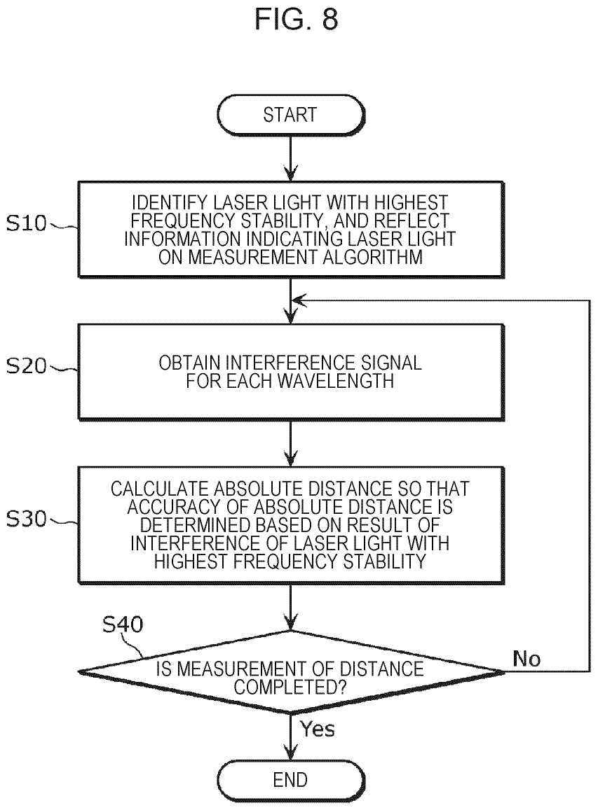

Subsequently, the operation of the distance measuring device 1 according to the present embodiment will be described with reference to FIG. 8.

FIG. 8 is a flowchart illustrating an example of the operation of the distance measuring device 1 according to the present embodiment.

First, the processing circuit 30 identifies the laser light having the highest frequency stability, in other words, having the lowest fluctuation of the frequency among a plurality of single-wavelength laser light beams used by the MWI, and reflects information indicating the identified laser light on a measurement algorithm (S10). The standard deviation o representing the fluctuation of the frequency is, for example, information included in a data sheet, specifications and the like of the light source. The processing circuit 30 can identify the laser light with the lowest fluctuation of the frequency by reading the information for each light source. The information indicating the identified laser light is input to the measurement algorithm.

Note that fluctuation information of the frequency of the single-wavelength laser light can be obtained by measuring temporal frequency fluctuations for all single-wavelength laser light beams using e.g., an optical wavelength meter. The fluctuation may be evaluated in advance, and the information thereof may be read before the measurement, or the single-wavelength laser light with the lowest fluctuation may be identified in real time while evaluating the fluctuation of the frequency concurrently with the distance measurement.

Subsequently, the processing circuit 30 obtains an interference signal of a plurality of single-wavelength laser light beams for each wavelength by the MWI measurement (S20). Specifically, the light source 10 emits a plurality of single-wavelength laser light beams, and each of the light detectors 53 and 54 outputs a signal according to a detected light intensity.

Next, the processing circuit 30 calculates the absolute distance by a calculation algorithm for absolute distance so as to determine the accuracy of the absolute distance based on the interference result of the single-wavelength laser light with the highest frequency stability (S30). Specifically, the processing circuit 30 calculates the first distance by utilizing, for the first measurement, the interference signal for the wavelength of the single-wavelength laser light with the highest frequency stability, in other words, with the lowest fluctuation of the frequency. In addition, the processing circuit 30 calculates the second distance by utilizing, for the second measurement, the interference signal for the wavelength of the single-wavelength laser light with the lowest fluctuation of the frequency, and the interference signal for the wavelength of the other single-wavelength laser light. The processing circuit 30 calculates the absolute distance from the distance measuring device 1 to the object 90 based on the first distance and the second distance.

When the measurement of distance is continued (No in S40), the flow returns to step S20, and an interference signal for each wavelength is obtained. For example, for the purpose of obtaining the surface profile of the object 90, an interference signal may be obtained after the posture and/or position of the object 90 are changed.

When the measurement of distance is completed (Yes in S40), the distance measuring device 1 finishes the measurement. The distance measuring device 1 may output and display a measurement result on a display or the like.

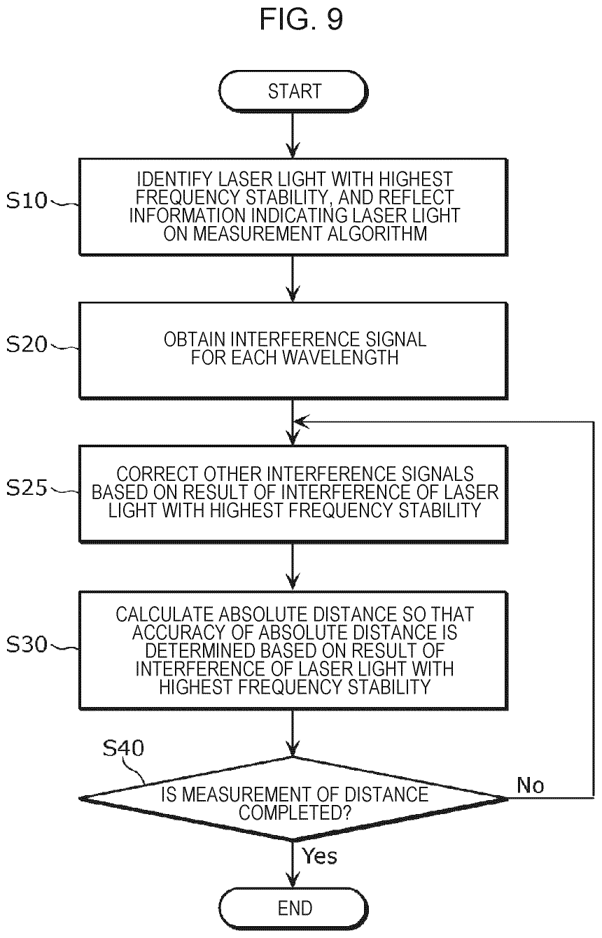

Note that the operation illustrated in FIG. 8 is merely an example. In the following, another operation example of the distance measuring device 1 will be described with reference to FIG. 9.

FIG. 9 is a flowchart illustrating another example of the operation of the distance measuring device 1 according to the present embodiment. The operation illustrated in FIG. 9 differs from the operation illustrated in FIG. 8 in that after obtaining an interference signal, the processing circuit 30 corrects the interference signal (S25) before calculating an absolute distance.

Specifically, the processing circuit 30 corrects another interference signal based on the interference result of the laser light with the highest frequency stability, in other words, with the lowest fluctuation of the frequency. For example, the processing circuit 30 corrects the second signal output from the light detector 54 that detects the light with the wavelength λ₂ based on the first signal output from the light detector 53 that detects the light with the wavelength λ₁. As an example, the processing circuit 30 estimates the fluctuation of the wavelength λ₂ by comparing the intensity of the signal with the wavelength λ₁ with the intensity of the signal with the wavelength λ₂. Estimating the fluctuation of the wavelength λ₂ can change the value of the wavelength utilized for calculation of the distance closer to the value of the actual wavelength. Thus, the accuracy of the calculated distance can be further increased.

### 6. Modification

Subsequently, a modification of the embodiment will be described.

The present modification mainly differs from the embodiment in that the number of wavelengths of the single-wavelength laser light utilized for distance measurement is three. In the following, the point of difference from the embodiment will be described, and a description of common points will be omitted or simplified.

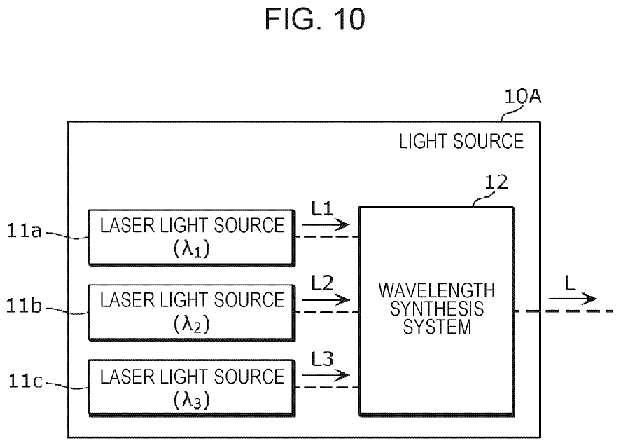

FIG. 10 is a block diagram illustrating the configuration of a light source 10A of a distance measuring device according to the present modification. As illustrated in FIG. 10, the light source 10A includes three laser light sources 11a, 11b and 11c, and a wavelength synthesis system 12. The laser light sources 11a and 11b are the same as those in the embodiment, thus a description will be omitted.

The laser light source 11c is e.g., a semiconductor laser element, and upon receipt of a current supplied, emits predetermined single-wavelength laser light. The laser light source 11c is an example of a third laser light source, and emits laser light L3 with a wavelength λ₃. The wavelength λ₃ is an example of the third wavelength, and the laser light L3 is an example of third single-wavelength laser light. The wavelength λ₃ is different from any of the wavelength λ₁ and the wavelength λ₂. In the present embodiment, the wavelength λ₃ is longer than any of the wavelength λ₁ and the wavelength λ₂. For example, the difference between the wavelength λ₃ and the wavelength λ₁ may be greater than or equal to 10 times the difference between the wavelength λ₂ and the wavelengthλ₁. A large difference is provided between the differences of two wavelengths, specifically, the beat wavelength between the wavelength λ₃ and the wavelength λ₁ can be made significantly different from the beat wavelength between the wavelength λ₂ and the wavelength λ₂. As a result, the measurement range and the measurement accuracy can be set stepwise, thus the absolute distance can be measured with high accuracy.

The wavelength synthesis system 12 synthesizes the laser light L1, L2 and L3 respectively emitted from the three laser light sources 11a, 11b and 11c. Light L emitted from the wavelength synthesis system 12 is coupled in the interference optical system 40. The wavelength synthesis system 12 is e.g., a DWDM element or a holographic optical element.

The configuration of the distance measuring device according to the present modification excluding the light source 10A is the same as the configuration of the distance measuring device 1 illustrated in FIG. 1. The light-receiving optical system 50 of the optical unit 20 includes a light detector that detects light with the wavelength λ₃. Alternatively, the light-receiving optical system 50 of the optical unit 20 may detect beat light by heterodyne interferometry.

When three single-wavelength laser light beams having different wavelengths can be utilized as in the present modification, there are three combinations of two single-wavelength laser light beams. Thus, the second measurement can be performed based on at least one of the three combinations. Specifically, the second measurement can be performed with the measurement accuracy and the measurement range according to at least one of beat wavelength Λ₁₂, beat wavelength Λ₁₃, or beat wavelength Λ₂₃, the beat wavelength Λ₁₂ being generated by interference between the laser light L1 with the wavelength λ₁ and the laser light L2 with the wavelength λ₂, the beat wavelength Λ₁₃ being generated by interference between the laser light L1 with the wavelength λ₁ and the laser light L3 with the wavelength λ₃, the beat wavelength Λ₂₃ being generated by interference between the laser light L3 with the wavelength λ₃ and the laser light L2 with the wavelength λ₂.

Note that the beat wavelength Λ₁₂ is represented by Expression (2). The beat wavelengths Λ₁₃ and Λ₂₃ are represented by the following Expressions (4) and (5), respectively.

$${Λ}_{13} = \frac{{λ}_{1} {λ}_{3}}{\vert {λ}_{1} - {λ}_{3} \vert} \qquad ( 4 )$$

$${Λ}_{23} = \frac{{λ}_{2} {λ}_{3}}{\vert {λ}_{2} - {λ}_{3} \vert} \qquad ( 5 )$$

In the present modification, λ₁<λ₂<λ₃ is satisfied. Also, |λ₁−λ₃| is set to be sufficiently larger than |λ₁−λ₂|. Simply stated, it is set that λ₁≈λ₂. As a result, the beat wavelength Λ₁₂ and the beat wavelength Λ₁₃ can be made significantly different from each other. For example, λ₁, λ₂, λ₃ are assumed to be 1550 nm, 1551 nm, 1600 nm, respectively. In this situation, from Expression (2) and Expression (4), the beat wavelength Λ₁₂ is approximately 2.4 mm, and the beat wavelength Λ₁₃ is approximately 50 μm. Since λ₁≈λ₂, the beat wavelength Λ₁₃ is substantially equal to the beat wavelength Λ₂₃.

The processing circuit 30 according to the present modification performs the second measurement by utilizing two among the beat wavelengths Λ₁₂, Λ₁₃ and Λ₂₃, and calculates the distance from the distance measuring device 1 to the object 90 by combining the second measurement results and the first measurement results. Specifically, the processing circuit 30 calculates the absolute distance from the distance measuring device 1 to the object 90 by combining the first distance obtained by the first measurement and two second distances obtained by the second measurement.

The processing circuit 30 utilizes the beat wavelength based on the laser light with the lowest fluctuation of the frequency among all single-wavelength laser light beams emitted by the light source 10A. Because the laser light L1 has the lowest fluctuation of the frequency, the beat wavelength Λ₁₃ and the beat wavelength Λ₁₂ are utilized. In the first measurement also, the processing circuit 30 utilizes the interference result of the laser light with the lowest fluctuation of the frequency among all single-wavelength laser light beams emitted by the light source 10A.

Let x be the absolute distance from a probe to a measurement object, then the absolute distance x can be represented by the following Expression (6).

$$x = ( A \times {Λ}_{13} + B \times {λ}_{1} + {θ}_{i} \times {λ}_{1} ) / 2 \qquad ( 6 )$$

A and B are the wave numbers of the beat wavelength Λ₁₃ and the wavelength λ₁, respectively, included within the absolute distance xi to a point 91 in the object 90. Also, θᵢ corresponds to each position of points 91, 92, 93 in the object 90, and represents the phase of an interference result based on the wavelength λ₁obtained by the first measurement. Note that Expression (6) corresponds to expanded version of Expression (3) with 3 wavelengths.

The second measurement is performed in a wavelength combination that achieves the longest beat wavelength. The distance calculated by the second measurement is an example of a third distance which is calculated with a third measurement accuracy in a third measurement range. Note that the third measurement accuracy is lower than the second measurement accuracy and the first measurement accuracy. The third measurement range is longer than the second measurement range and the first measurement range. Simply stated, the second measurement is performed in a wavelength combination that achieves the longest measurement range.

Here, the processing circuit 30 identifies the phase of the beat wavelength Λ₁₂ based on a combination of the wavelength λ₁ and the wavelength λ₂. The processing circuit 30 counts a wave number A of the beat wavelength Λ₁₃ of the subsequent second measurement based on the identified phase of the beat wavelength Λ₁₂. Specifically, the processing circuit 30 calculates the wave number A of the beat wavelength Λ₁₃ using the components of the quotient obtained by dividing the distance calculated based on the beat wavelength Λ₁₂ by the beat wavelength Λ₁₃.

Furthermore, the processing circuit 30 identifies the phase of the beat wavelength Λ₁₃ based on a combination of the wavelength λ₁ and the wavelength λ₃ as the subsequent second measurement. The processing circuit 30 counts a wave number B of the wavelength λ₁ in the first measurement based on the identified phase of the beat wavelength Λ₁₃. Specifically, the processing circuit 30 calculates the wave number B of the wavelength λ₁ by dividing the distance calculated based on the beat wavelength Λ₁₃ by the wavelength λ₁.

Finally, the processing circuit 30 identifies the phase θ₁ of the wavelength λ₁ as the first measurement. The processing circuit 30 can calculate the absolute distance xᵢ by the above-mentioned Expression (6) based on the wave numbers A and B, and the phase θ₁ of the wavelength λ₁.

As described above, the measurement range can be further expanded by performing the second measurement multiple times by utilizing a plurality of beat wavelengths.

Note that the absolute distance may be calculated by a method other than the above-described method. For example, an Excess fraction method may be used, which calculates the absolute distance by a combination of the phases of all wavelengths of the laser light beams to be used.

### Other Embodiments

So far, the distance measuring device according to one or multiple aspects have been described based on the embodiments; however, the present disclosure is not limited to these embodiments. Within a scope not departing from the spirit of the present disclosure, embodiments obtained by making various modifications, which occur to those skilled in the art, to the above embodiments, and the embodiments that are constructed by combining the components in different embodiments are also included in the scope of the present disclosure.

For example, the above embodiments and modifications illustrate examples in which the processing circuit 30 calculates the absolute distance from the distance measuring device 1 to the object 90, but are not limited to these examples. After calculating the first distance and the second distance, the processing circuit 30 may output these distances to another device. For example, the processing circuit 30 may transmit the first distance and the second distance to another computer, and cause the computer to calculate the absolute distance. Alternatively, the processing circuit 30 may transmit the first distance and the second distance to a display for displaying the distances on the display, or may output to a printer for printing the distances on a medium such as paper. Thus, the first distance and the second distance can be presented to a user or the like, thus the user can calculate the absolute distance by hand calculation. Thus, the processing circuit 30 may not calculate the absolute distance.

Also, the wavelength of at least one of two single-wavelength laser light beams may be changeable. For example, the wavelength of laser light with the higher fluctuation of the frequency may be swept. Thus, the combination of two wavelengths can be changed, therefore the measurement range and the measurement accuracy suitable for the object 90 can be achieved. As compared to when three or more laser light sources are provided, miniaturization of the device can be achieved.

Also, one single-wavelength laser light is split into one laser light, and the other laser light with a shifted frequency, which may be utilized as two single-wavelength laser light beams. As a unit to shift the frequency, e.g., an acousto-optic modulator (AOM) may be utilized.

Also, the fluctuation of the frequency may not be the standard deviation σ. For example, the fluctuation of the frequency may be 3σ. Alternatively, the fluctuation of the frequency may be the variance σ² of the frequency of the laser light in a finite time. Also, the fluctuation of the frequency may be the difference between a maximum value and a minimum value of the frequency of the laser light in a finite time.

When the light source includes three or more laser light sources, two of the laser light sources may emit single-wavelength laser light with the same wavelength. In addition, two single-wavelength laser light beams with the same wavelength may have the same fluctuation of the frequency. In the first measurement, one of the two single-wavelength laser light beams with the same wavelength may be utilized, and in the second measurement, the other of the two single-wavelength laser light beams with the same wavelength may be utilized. In other words, the first single-wavelength laser light beams utilized in the first measurement and the second measurement may be emitted from different laser light sources.

Also, the measurement accuracy Am of the second measurement may be greater than the measurement range Rs of the first measurement. When there is a slight difference between the measurement accuracy Am of the second measurement and the measurement range Rs of the first measurement, and Am>Rs, it is possible to perform distance measurement with an accuracy essentially equal to the accuracy when Am≤Rs.

General or specific embodiments of the present disclosure may be implemented as a system, an apparatus, a method, an integrated circuit or a computer program. Alternatively, the embodiments may be implemented as a non-transitory computer-readable recording medium, such as an optical disk, an HDD or a semiconductor memory, in which the computer program is stored. Alternatively, the embodiments may be implemented by any combination of a system, an apparatus, a method, an integrated circuit, a computer program and a recording medium.

For the embodiments described above, various changes, replacements, additions, omissions can be made within the scope of the claims or the equivalent thereof.

The present disclosure can be utilized for the distance measuring device that can achieve both a long measurement range and a higher measurement accuracy, and is applicable to e.g., a surface profile inspection device.

What is claimed is:

1. A distance measuring device comprising:
a light source that emits first single-wavelength laser light with a first wavelength, and second single-wavelength laser light with a second wavelength different from the first wavelength;
an optical unit that
causes interference between a plurality of light beams incident on the optical unit,
detects a first light component with the first wavelength among interfering light generated by the interference of the plurality of light beams, and outputs a first signal according to a result of a detection of the first light component, and
detects a second light component with the second wavelength among the interfering light, and outputs a second signal according to a result of a detection of the second light component; and
a processing circuit that processes the first signal and the second signal, wherein
the processing circuit
calculates a first distance in a first range with a first accuracy based on the first signal, and
calculates a second distance in a second range with a second accuracy based on the first signal and the second signal,
the first accuracy is higher than the second accuracy,
the second range is longer than the first range, and
a frequency stability of the first single-wavelength laser light is higher than a frequency stability of the second single-wavelength laser light.

2. The distance measuring device according to claim 1,
wherein the second accuracy is less than or equal to the first range.

3. The distance measuring device according to claim 2,
wherein the processing circuit further calculates a distance from the distance measuring device to an object based on the first distance and the second distance.

4. The distance measuring device according to claim 3,
wherein the processing circuit calculates an absolute distance from the distance measuring device to the object.

5. The distance measuring device according to claim 1, wherein
the plurality of light beams include the first single-wavelength laser light, the second single-wavelength laser light, first reflected light generated by reflection of the first single-wavelength laser light on an object, and second reflected light generated by reflection of the second single-wavelength laser light on the object, and
the optical unit
outputs the first signal by causing interference between the first single-wavelength laser light and the first reflected light and detecting the first light component, an
outputs the second signal by causing interference between the second single-wavelength laser light and the second reflected light and detecting the second light component.

6. The distance measuring device according to claim 5, wherein
the optical unit includes a beam splitter, a first light detector, and a second light detector,
the beam splitter splits the first single-wavelength laser light from the light source into first reference light and first detection light, and splits the second single-wavelength laser light from the light source into second reference light and second detection light,
the first reflected light is generated by reflection of the first detection light on the object,
the second reflected light is generated by reflection of the second detection light on the object,
the first light detector outputs the first signal by detecting the first light component generated by interference between the first reference light and the first reflected light, and
the second light detector outputs the second signal by detecting the second light component generated by interference between the second reference light and the second reflected light.

7. The distance measuring device according to claim 6, wherein
the optical unit includes
an optical element that causes the first reference light and the second reference light to be incident on the beam splitter, and
a wavelength-separation element that separates incident light into light with the first wavelength and light with the second wavelength, and
the beam splitter emits at least part of each of the first reflected light and the second reflected light from the object, and at least part of each of the first reference light and the second reference light from the optical element to the wavelength-separation element.

8. The distance measuring device according to claim 5,
wherein the processing circuit corrects the second signal based on the first signal.

9. The distance measuring device according to claim 1,
wherein a set frequency of the first single-wavelength laser light and a set frequency of the second single-wavelength laser light are fixed during a measurement period.

10. The distance measuring device according to claim 1,
wherein the light source further emits third single-wavelength laser light with a third wavelength different from any of the first wavelength and the second wavelength.

11. The distance measuring device according to claim 10,
wherein the first single-wavelength laser light has highest frequency stability among all single-wavelength laser light emitted by the light source.

12. The distance measuring device according to claim 10, wherein
the optical unit further detects a third light component with the third wavelength among the interfering light, and outputs a third signal according to a result of a detection of the third light component,
the processing circuit further calculates a third distance in a third range with a third accuracy based on the first signal and the third signal,
the third accuracy is lower than the second accuracy, and
the third range is longer than the second range.

13. The distance measuring device according to claim 1,
wherein the processing circuit calculates the second distance by calculating a phase of a beat wavelength between the first wavelength and the second wavelength based on the first signal and the second signal.

14. The distance measuring device according to claim 13,
wherein the processing circuit
calculates the first distance by calculating a phase of the first wavelength based on the first signal, and
calculates an absolute distance from the distance measuring device to an object by combining the first distance and the second distance.

15. The distance measuring device according to claim 1,
wherein the light source includes:
a first laser light source that emits the first single-wavelength laser light; and
a second laser light source that emits the second single-wavelength laser light.
